(19) United States
(12) Patent Application Publication
(10) Pub. No.: US 2012/0073903 A1
(43) Pub. Date: Mar. 29, 2012

(54) STEPLADDER

(75) Inventor: Gunther Krause, Alsfeld (DE)

(73) Assignee: KRAUSE-WERK GMBH & CO. KG, Altenburg (DE)

(21) Appl. No.: 13/375,942

(22) PCT Filed: Jun. 1, 2010
(86) PCT No.: PCT/EP2010/057648

§ 371 Date: Dec. 8, 2011

(30) Foreign Application Priority Data
Jun. 3, 2009 (DE) 20 2009 004 879.9

(51) Int. Cl. E06C 1/28

(52) U.S. Cl. 182/159

(57) ABSTRACT

A stepladder having front stiles with steps extending therebetween, rear stiles connected to the front stiles in a hinged manner, a connecting member extending between the top ends of the front stiles, and a U-shaped bracket, extending from the connecting member which can swivel and/or slide and which spans a plane extending transversely to the stepladder in the usage position. Connecting member has a through-hole, said through-hole enabling a connection to the cavity of the front stiles, each through-hole is penetrated by a respective side limb of the bracket, in a first position of the bracket the side limbs extend within the cavities and the cross limb be accommodated by the connecting member, and in a second position of the bracket, said bracket extends on the plane extending transversely to the stepladder and the side limbs extend outside the cavities and are supported at the ends on the connecting member.

The invention concerns a stepladder comprising a first cross-beam or riser beam with rungs running between them, a second cross-beam or support beam, hinged, connected to the first cross-beam, connected, a connection element such as a shell element, which is connected to the upper end of the first cross-beam, as well as a U-shaped hanger, which exhibits hanger side-legs and a hanger cross-leg and comes out, hinged and/or adjustable, of the shell element, whereby in the use position of the hanger a plane extends running across to the stepladder.

A corresponding stepladder may to gathered from the patent DE-U-70 08 741. A storage shell comes out of the upper end of the ladder beam for tools. To increase the support surface, a wire hanger is provided, which can either be pulled out of the cross-beam or the side bracket of the shell or can be inserted into it.

From DE-U-20 2007 002 103, a stepladder may be gathered, which exhibits a first and a second hanger connecting the cross-beam of the stepladder, one of which can be moved with its side-legs into the cross-beam.

The object of patent GB-A-2 371 078 to be gathered is a stepladder with a mountable cross-hanger which can be connected at the riser beam and a shell detachable from it.

A stepladder according to GB-A-2 192 025 offers the possibility, in the area of the ends of the riser beam, of attaching a shell which is adjustable.

The object on which the present invention is based is to develop a stepladder of the type mentioned in the beginning so that the hanger can be stably fixed in the use position, in order to also be able, in particular, to hold heavy objects such as frame buckets, shells, and so on. Also, the hanger must be kept from falling off. In a further aspect of the invention, if the hanger is not going to be used, then secure stowage should be possible.

To solve the problem, the invention provides, essentially, that the connection or shell element in the area of every first cross-beam exhibits a perforation, making possible a connection to the space of the first cross-beam, that each perforation is penetrated by a respective one of the hanger side-legs, that the hanger side-leg is extended in a first position of the hangers inside the space of the first cross-beam and the cross-leg is received by the connection or shell element or runs into this area and that in a second position of the hanger this runs in a plane extending across to the stepladder, the hanger side-legs run outside the space of the first cross-beam and are supported at the end on the connection or shell element, whereby at least one of the hanger side-legs exhibits a true cross-section in its free end area that is greater than the true cross-section of the perforation.

In particular, each free end of the hanger side-legs exhibits a corresponding cross-sectional geometry, which is preferably attained through a jacket or a cap e.g. made of plastic. Of course, the invention is also not departed from if the cross-sectional geometry is achieved by distorting the ends of the hanger side-leg.

Based on the teaching according to the invention, a stepladder is proposed with a hinged hanger and which can be moved into the cross-beams bearing rungs, which in the area of the shell element offer an opening for e.g. a pail or an additional shell. At the same time, the shell element always penetrates the hanger, which takes up the lever forces that are transmitted through the hanger. For this, it is provided that the legs are supported at their end areas on the side opposite the connection or shell element, hereinafter called a simplified shell element. Consequently, the shaping of the shell element is likewise judged to be intrinsically inventive.

Preferably, the shell element exhibits, in a front view, that is, in the direction of a plane extended from the first cross-beam, a U-shape with side legs and a cross-leg, in which the side-legs run inside the cross-beam and are connected to it, such as being screwed to it. The side-legs should exhibit a U-profile geometry, which is adjusted to the inside geometry of the cross-beam, so that the hanger legs are disposed generally without any play in the cross-beams.

The invention would then of course not be departed from if the cross-beams are held at the ends by the side-legs.

The cross-leg of the storage element encloses a first and a second section, which extend respectively between the cross-beams. At the same time, the first and the second sections respectively extend a plane and run staggered to one another in order to form a ledge. Between the first and the second sections runs a bridge-like wall. In its area, the perforations are made available that have penetrated from the hanger legs, which penetrate area-wise both the first section and the bridge-like wall.

The first and the second sections therefore form a rung, so that upon pulling the hanger out, this is supported on the one hand on the outside of the first section and on the other hand on the inside of the second section. As a result, in the area of the perforations of the first and second section, first and second supports form for the ends of the hanger side-legs.

In particular, it is provided that the plane in plan view, that is, running approximately parallel to the standing surface of the ladder, comprises a cross-leg exhibiting a U-shape of the shell element of a first and a second section extending over the length of the cross-leg, that the first section exhibits side areas running in the area of the side-legs of the shell element, that the side areas are first supports for the hanger side-leg in the second position of the hanger, and that the first section exhibits an outer surface, which runs staggered and beneath the outer surface of the second section.

In the development of the invention, it is provided that the bridge-like wall merges laterally into the peripheral walls bounding the first section, which rises above the upper side of the first section.

At some distance from the peripheral walls and the bridge-like wall, stop projections rise out of the first section, whose internal distances from the side facing the peripheral walls or the bridge-like wall are adjusted to the cross-section of the hanger leg, so that a clipping or stopping of the hanger is possible in the use position or in an unused state.

In the unused state (first hanger position), as mentioned the hanger preferably is fixed between the bridge-like interwall, which extends between the first and second section of the shell element, and the stop projection of projections is/are at some distance from this. In order to facilitate pulling the hanger out and thereby grasping the cross-leg, a trough-like depression is preferably made available in the central area of the first section, which can extend at least area-wise in as far as the second section.

In order to ensure at least a linear fit of the end area of the hanger to both the outside of the first section and to the inside of the second section, it is provided that the respective hanger side-leg be cropped and comprise a first hanger section and a second hanger section staggered and running parallel to it, whereby in the use position (second position) of the hanger, the section running on the hanger cross-leg side is supported laterally running section as a first hanger section at the first section of the storage element and the end section is supported as a second hanger section on the inside of the second sections.

The end area exhibits the geometry of a rung.

Furthermore, in the second section of the shell element perforations of different sizes, if necessary, are available in order to hold tools.

As a result of existing caps, particularly those made of plastic, being fastened, such as being glued, for the cross-section widening at the ends of the hanger side-legs, a further advantage is achieved. In standard stepladders, the distance of the first cross-beam from below upward is reduced. As a result of this, the ends of the hanger side-legs fit tightly, depending on the run, inside the cross-beam on the inside surface of the cross-beam. Because the hanger is made of metal, a disruptive grating noise consequently exists both upon pushing in and pulling out and possible wear occurs, which is avoided as a result of using one made of plastic.

Further details, advantages, and features of the invention are provided not only in the claims, whose features are to be gathered, alone or in combination, as well from the following description of the preferred embodiments to be gathered from one of the drawings

Shown are:

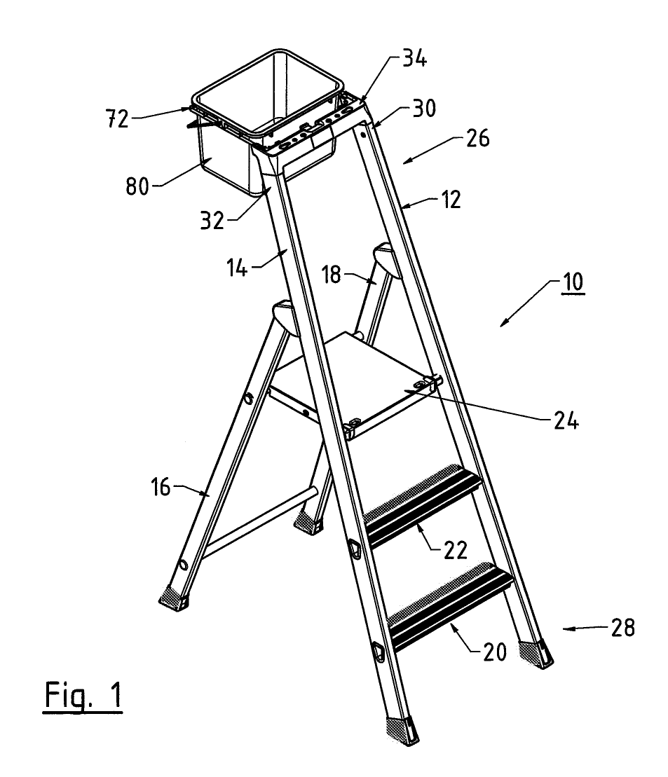

FIG. 1 a stepladder,

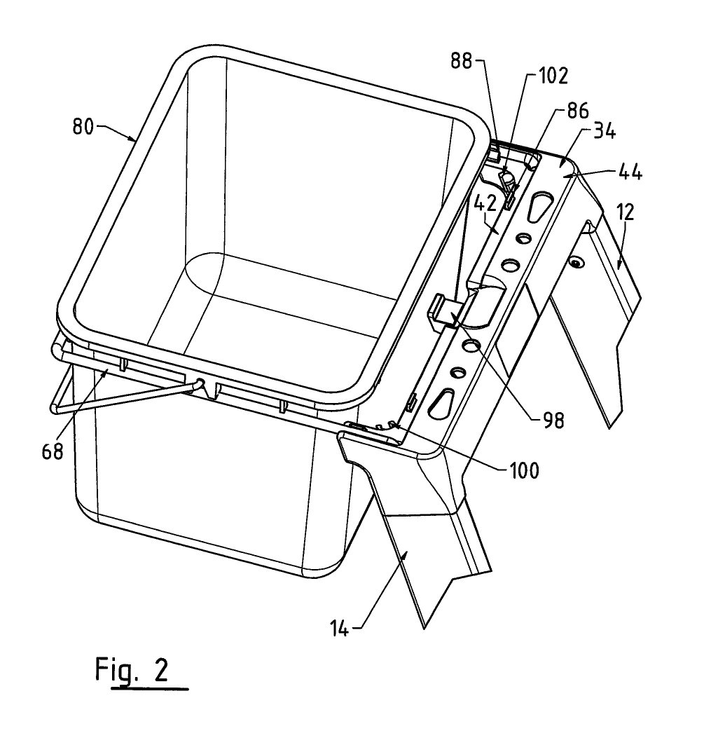

FIG. 2 a portion of the stepladder according to FIG. 1 in a magnified depiction,

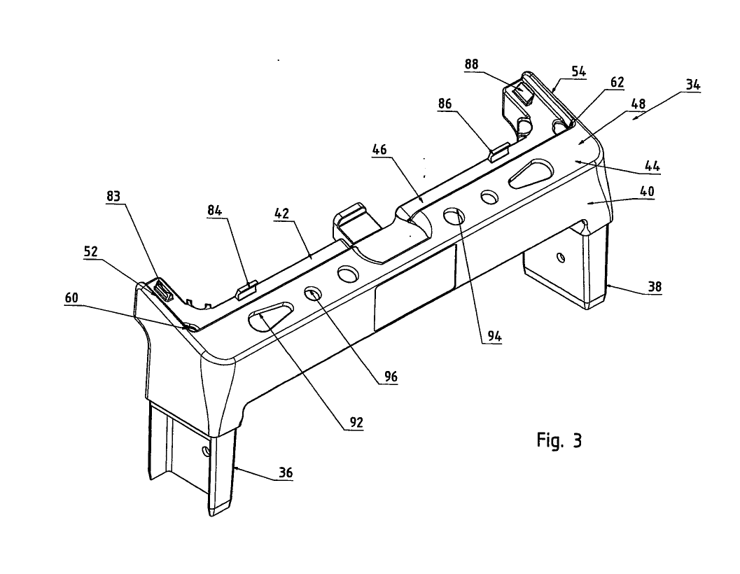

FIG. 3 a perspective representation of a hanger, which comes out of the upper end of the cross-beam of the stepladder according to FIGS. 1 and 2,

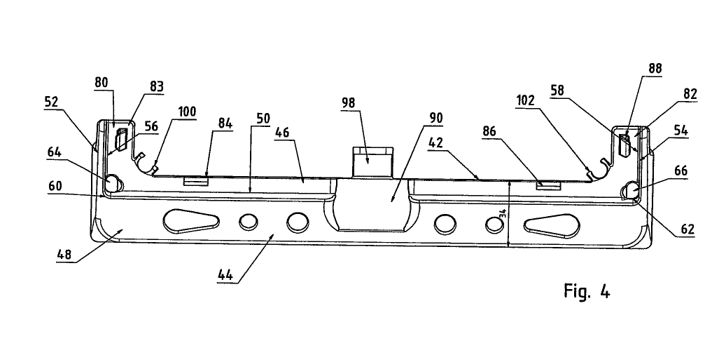

FIG. 4 the hanger according to FIG. 3 in plan view,

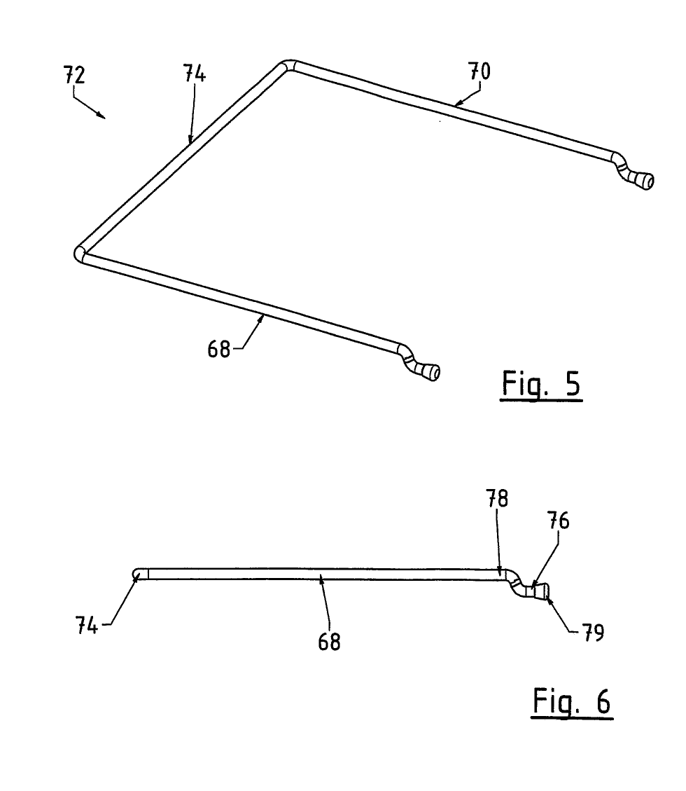

FIG. 5 a hanger in perspective representation,

FIG. 6 a hanger according to FIG. 5 in a side view,

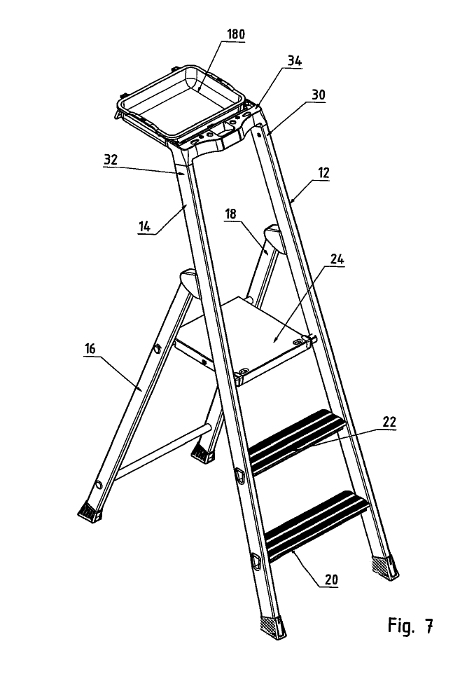

FIG. 7 a further embodiment of a stepladder similar to FIG. 1, with a hanger in the use position,

FIG. 8 a portion of the stepladder according to FIG. 7,

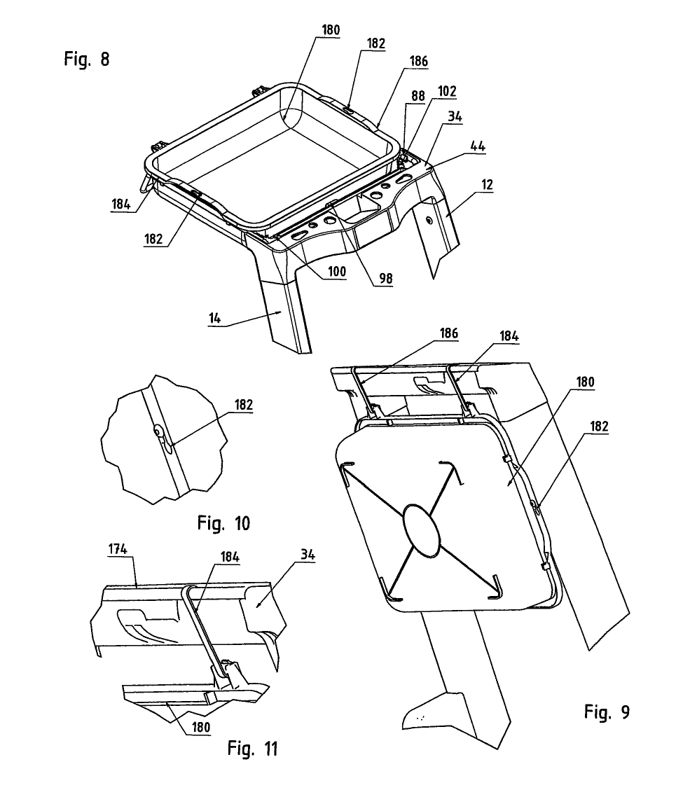

FIG. 9 a portion of the stepladder according to FIG. 7 and/or FIG. 8 with the hanger in transport position,

FIG. 10 a detail of FIG. 9,

FIG. 11 a further detail of FIG. 9,

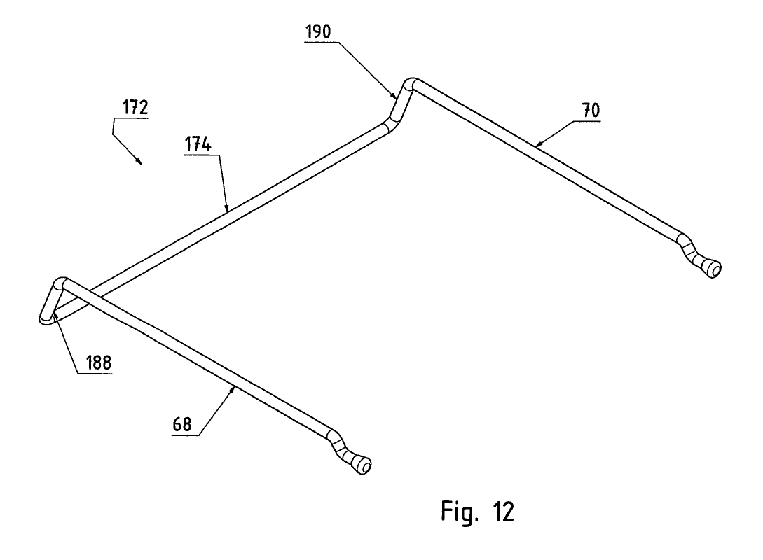

FIG. 12 a second embodiment of a hanger in perspective representation, and

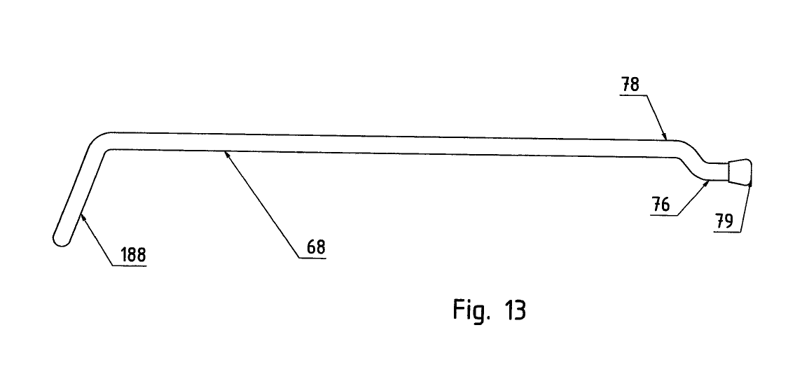

FIG. 13 the hanger according to FIG. 12 in a side view.

FIG. 1 is a principal and perspective representation of a stepladder 10 to be gathered, which comprises a first cross-beam or riser beam 12, 14 and a hinged support beam connected to it, forming a second cross-beam 16, 18. Between the riser beams 12, 14 run rungs 20, 22 in the lower area in a customary manner and in the upper area a step plate 24. In this regard, reference is made to a sufficiently well-known construction. Furthermore, the riser beams 12,14 slope toward one another, so that as a result of this the distance in the upper area 26 is less than in the foot area 28. The construction in this regard is however not to be understood as being limited in protection.

A hollow-body-like connection element, such as a shell 34, comes out of the upper ends 30, 32 of the riser beams 12, 14, which with the aid of FIGS. 3 and 4 is described in detail. By reason of simplification, the connection element is shown below as a shell 34. The shell 34 made, in particular of plastic, which can be a sprayed die casting, exhibits a U-shape, both in the front vie, that is, in the direction of the riser beams 12, 14 and in plan view, that is, in the direction of the standing surface of the stepladder 10.

The shell 34 includes in the U-shaped section side-legs 36, 38, whose outside geometry is adjusted to the inside geometry of the riser beams 12, 14, in order to be used on it almost without any play and furthermore to be screwed to it. In this respect, this involves a basically known construction at the shell 34.

The cross-leg 40 connecting the side-legs 36, 38 consists of a first section 42, U-shaped in plan view, which runs on the support-beam side, and a second section 44. The sections 42, 44 exhibit upper outside surfaces 46, 48 extending in planes running staggered to one another, which on a ladder 10 set up run approximately horizontally. Between the outside surfaces 46, 48 lying in planes running in staggered to one another and preferably parallel to one another extends an interwall 50, which passes through into side-edge sections 52, 54, which rise above the outside surface 46 of the first sections 42 and connected to their upper edges 56, 58 penetrate into the outside surface 48 of the second section 44. The side edges furthermore restrict the side-legs of the U-shaped first sections 42 of the shell 34 on the outside.

The outside surfaces 46,48 consequently form a rung with the interwall 50.

In the corner areas 60, 62, the outside surface 46 of the first sections 42, which runs above the space surrounded by the side-legs 36, 38 and thus the shell 34 fastened to the riser beams 12, 14 above the space of the riser beams 12, 14, perforations 64, 66 are available, which extend area-wise into the first section 42 and area-wise into the interwall 50.

The perforations 64, 66 are penetrated by the side-legs 68, 70 of a hanger 72. The hanger 72 assumes two positions, namely a first position, in which the hanger 72 is not used and a second position which corresponds to a use position. In the first position, the side-legs 68, 70 extend inside the space of the riser beams 12, 14. If the hanger 72 is being used, that is, in the second position, the side-legs 68, 70 run outside the riser beams 12, 14 and are supported by the shell 34.

The hanger 72, which can involve a wire hanger, exhibits a U-shape, so that as a result the side-legs 68, 70 are connected by r a cross-leg 74. The ends of the side-legs 68, 70 are cropped, that is, the section 76, 78 exhibit planes running staggered to one another, such as FIG. 6 provides in the side view. The outer end section 76 running beneath the planes extended by the hanger 72 is furthermore provided at the ends with a plastic cap 79, whose true cross-section is greater than the true cross-section of the perforation 64 and/or 66 is. Consequently, if it results that the hanger 72 should come loose, to which it is mounted, that is, the hanger 72, i.e. the perforations 64, 66 have gone through its side-legs 68, 70 and then to the ends, that is, in FIG. 6 the plastic caps 79 are fastened, such as being glued, to the sections 76.

In the use position, the outer section 76 fits tightly, bent toward the inside of the second section 44 of the shell 34. The inner end section 78 running in the plane of the hanger 72 rests at the transverse side surfaces 80, 82 of the outside 46 of first section 42. Thus forces are transmitted linearly by means of the hanger 72 to the shell 34, so that secure fastening is possible, in particular if, e.g. a pail 80 or a shell 180 corresponding to FIGS. 1 and 2 and/or 7-9 is picked up, which can be filled with paint, water, etc. or can serve as storage. Instead of a pail 80 or a shell 180, another element can also be used on the hanger 72.

From the representations of FIGS. 3 and 4, Furthermore, it results that projections such as detents 83, 84, 86, 88 come out of the outer surface 46 of the first section 42, which run at some distance from the inner surfaces of the peripheral walls 52, 54 and/or the interwall 50. At the same time, the internal distance between the projections such as detents 83, 84, 86, 88 and the inner surfaces facing the walls 50, 52, 54 are adjusted to the cross-section of the hanger 72, i.e. the side-legs 68, 70 and the cross-leg 74, so that in the non-use position (first position) the cross-leg 74 can be wedged between the projections 84, 86 and the interwall 50 and in the use position (second position) the side-legs 68, 70 can be wedged between the projections 83, 88 and at the inner surfaces of the peripheral walls 52, 54.

The cross-leg 74 can thereby be discerned if the hanger is not being used, that is, the side-legs 68, 70 are sunk into the riser beams 12,14, in order for the hanger side-legs 68, 70 to be able to be pulled out of the cross-beams 12, 14, as is provided in the embodiment example in the first and in the second section 42, 44 an aligned trough-like depression 90. A problem-free grip of the cross-leg 74 is thereby possible.

Preferably the hanger 72 is made out of wire material and exhibits a diameter between 5 and 7 mm, preferentially of 6 mm. The length of the hanger cross-leg preferably amounts to between 230 mm and 250 mm, without any restriction of the teaching according to the invention resulting thereby. The true length of the hanger side-legs 68, 70 that is, the area that projects above the hanger 36, should lie in the range between 210 mm to 230 mm, so that shell and pail can be hung relative to the large cross-section.

The second section 44 exhibits perforations or openings 92, 94, 96, in order e.g. to be able to insert tools. Furthermore, a hook-shaped projection 98 rises up aligned with the first section 42 and into the extension of the trough-like depression 90, in order to hold, e.g., a hanger for a pail.

Furthermore, projections forming clips 100, 102 come out of the inner corner of the first section 42, in order, e.g. to receive a clamping cable.

From FIGS. 7-13 a stepladder is to be gathered which corresponds constructively mainly to that of FIG. 1, so that identical reference numbers are used for identical elements. It is likewise true for the shell element 34 connecting the riser beams 12, 14, so that reference is made to the corresponding embodiments if identical geometrically. However deviations can result that do not affect the function, such as a comparison clarifies of the cross-leg 40 represented in Fig. of the shell element 34 by way of example.

The main difference between the embodiments of FIGS. 1-6 and 7-13 consists of the hanger 190 received by a U-hanger 172.

So the embodiment example of FIGS. 7-13 provides that the shell 180 during transport of the ladder can be pivoted and detented, as a comparison with FIGS. 8 and 9-11 makes clear. For this, the shell 180 in the area of the sections of the riser beams 12, 14 rising above the support beams 16, 18, and indeed to their back sides, e.g. are connected by means of clips or by rung-rivet/keyhole recess connections 182. The keyhole recess 182 is clearly recognizable with mating rivet or screws in FIGS. 8 and 9.

Furthermore, bar-shaped hooks 184, 186 come out of the front edge of the shell 180, which e.g. are made of spring steel and can be connected to the cross-leg 174 of the hangers 172, as results from FIG. 9.

Hanger 172 can be sunk, corresponding to the teaching according to the invention into the riser beams 12, 14, i.e. so that its side-legs 68, 70 can be pushed into the riser beams 12, 14. In this regard, reference is made to the construction and the features according to the invention that have been explained in relation to FIGS. 5 and 6 in particular.

Hanger 172 differs from hanger 72 in that the cross-leg 174 runs staggered to the planes extended by the side-legs 68, 70, that is, it is connected by the interlegs 188, 190 to the side-legs 68, 70. The construction in this regard is selected thereby, with side-legs 68, 70 sunk into the riser beams 12, 14, the cross-leg 174 runs, in the area of the front side of the connection and/or shell element 34, such that the hooks 184, 186 can run hinged approximately in one plane, which is extended by the upper edge surrounding the shell 180 upon fastening it to the riser beams 12, 14. This results both in FIG. 9 as well as in the detail of FIG. 11.

By means of this step, the possibility exists of the ladder with the shell 180 in its parked position, that is, in its problem-free position fixed to the riser beams 12, 14 of being transported without the shell 180 being able to be loosened unsupervised from the ladder 10 and without this hooks or these hooks 184,186 being able to lead to a hindrance.

If the shell 180 is used, then the hanger 172 is pulled out of the riser beams 12, 14 and brought into place, which is gathered from FIGS. 7 and 8. Before the connection between the shell 180 and its rivets coming out of the back side of the riser beams 12, 14 is released, that is, the shell 180 is moved such that the rivets reach in extension with the keyhole-like slots 182.

Consequently, the shell 180 is pivoted around the cross-leg 174, in which the hooks 184, 186 remain connected to the cross-leg 174. The shell 180 is thus inserted from the upper side into the frame extended by the hanger 172.

In the embodiment example, the shell 180 is as a result pivoted clockwise from the parked position (FIG. 9) into the use position (FIG. 7, FIG. 8).

1. A stepladder (10) including a first cross-beam or riser beam (12, 14) with rungs (20, 22) running between them, hinged with a second cross-beam or support beam (16, 18) connecting the first cross-beam, a connection or shell element (34), which is connected to it at the upper ends (30, 32) of the first cross-beam, as well as a U-shaped hanger (72, 172) exhibiting the hanger side-legs (68, 70) and a hanger cross-leg (74,174) and emerge pivotably or movably from the connection or shell element, in which in a use position of the hanger, it extends a plane running transverse to the stepladder,
characterized in that,
the connection or shell element (34) in the area of every first cross-beam (12, 14) exhibits a perforation (64, 66) making a connection possible to the space of the first cross-beam, that each perforation is penetrated by one of the hanger side-legs (68, 70) respectively, that in a first position of the hanger the hanger side-leg extends inside the space of the first cross-beam and the cross-leg (74, 174) is received by the connection or shell element (34) or runs in this area, and that in a second position of the hanger it runs in the plane extending transverse to the stepladder (10), the hanger side-legs run outside the space of the first cross-beam and are supported at the ends on the connection or shell element (34), whereby at least one of the hanger side-legs in its free end area (76) exhibits its true cross-section, which is greater than the true cross-section of the perforation.

2. The stepladder according to claim 1,
characterized in that
each hanger side-leg (68, 70) at its free end exhibits a cross-section that is greater than the related cross-section of the perforation (64, 66) in which the shell element (34) is.

3. The stepladder according to claim 1,
characterized in that
the true cross-section of the hanger side-legs (68, 70) is formed by one of caps (79) set on the free end (76).

4. The stepladder according to claim 3,
characterized in that
the cap (79) is made of plastic and is connected, such as being glued, to the free end (76) of the hanger side-legs (68,70).

5. The stepladder according to claim 1,
characterized in that
the connection or shell element (34) exhibits in front view a U-shape with side-legs (36, 38) and a cross-leg (40), wherein the side-legs (36, 38) run inside the first cross-beam (12, 14) and are connected, such as being screwed, to it.

6. The stepladder according to claim 5,
characterized in that
the side-legs (36, 38) of the connection or shell element (34) exhibits a U-profile geometry, which is adjusted to the inside geometry of the inside space of the first cross-beam (12,14).

7. The stepladder according to claim 1,
characterized in that
the connection or shell element (34) exhibits a U-shape in plan view.

8. The stepladder according to claim 5,
characterized in that
the cross-leg (40) exhibiting a U-shape in plan view of the connection or shell element (34) comprises a first and a second section (42, 44) extending over the length of the cross-leg, that the first section (42) exhibits side areas (80, 82) running in the area of the side-legs (36, 38) of the connection or shell element (34), that the side areas are first supports for the hanger side-legs (68, 70) in the second position of the hanger (72), and that the first section (42) exhibits an outer surface (46), which runs staggered and beneath the outer surface (48) of the second section (44).

9. The stepladder according to claim 8,
characterized in that
the outer surface (46) of the first section (42) exhibits in plan view a U-shaped run.

10. The stepladder according to claim 8,
characterized in that
the outer surfaces (46, 48) of the first and second sections (42, 44) run parallel to each other and perpendicular or approximately perpendicular to the side-legs (36, 38) of the connection or shell element (34), that the outer surfaces (46, 48) of the first and second sections (42, 44) pass through a bridge-like interwall (50) into one another, that the interwall (50) passes through into side-edge walls (52, 54), which extend along the outer surface (46) of the first section (42) and rise above it.

11. The stepladder according to claim 1,
characterized in that
the perforation (64, 66) runs in the corner area of the first section (42) which is U-shaped in plan view.

12. The stepladder according to claim 1,
characterized in that
the perforation (64, 66) penetrates the outer surface (46) of the first section area-wise as well as the interwall (50).

13. The stepladder according to claim 8,
characterized in that
the second section (42, 44) forms an inside second support of the hanger side-legs (68,70) in the second position of the hangers (72,172).

14. The stepladder according to claim 8,
characterized in that
in a central area of the first section (42) a trough-like depression (90) is made to hold the hanger cross-leg (74) in the first position of the hangers (72, 172).

15. The stepladder according to claim 14,
characterized in that
the trough-like depression (90) extends at least into the second section (44).

16. The stepladder according to claim 1,
characterized in that
stop projections (82, 84, 86, 88) rising up come out some distance from the side-edge walls (52, 54) of the first section (42) and the interwall (50) from the outer surfaces (46) of the first section, between which and the side-edge wall or interwall facing the hanger side-legs (68,70) or the hanger cross-leg (74) can be or is fastened.

17. The stepladder according to claim 1,
characterized in that
each hanger side-leg (68, 70) is cropped at the ends and exhibits a first hanger section (76) and a second hanger section (78) staggered and running parallel to the first hanger section, in which in the second position of the hanger (72, 172) the section running on the hanger cross-leg side is supported as a first hanger section (78) at the first section (42) of the shell element (34) and the second hanger section is supported on the inside of the second section (44) of the shell element.

18. The stepladder according to claim 8,
characterized in that
the second section (44) of the connection or shell element (34) exhibits perforations, of different dimensions, if necessary, for receiving tools.

19. The stepladder according to claim 1,
characterized in that
the hanger (72,172) is a bent wire hanger.

20. The stepladder according to claim 1,
characterized in that
the hanger side-legs (68, 70) exhibit a length such that in the second position of the hanger (72,172) a pail can be hung from the hanger.

21. The stepladder according to claim 8,
characterized in that
a hook-shaped projection comes out of the first section (42) and preferably in extension of a trough-like depression (90).

22. The stepladder according to claim 8,
characterized in that
clip-like receptacles (100, 102) emerge from the inner corner of the first section (42).

23. The stepladder according to claim 8,
characterized in that
a hook-like projection (98) runs in a plane that runs parallel to a plane extended by the first section (42) or runs in it.

24. The stepladder according to claim 22,
characterized in that
the clip-like receptacles (100, 102) run in a plane that runs parallel to a plane extended by the first section (42) or runs in it.

25. The stepladder according to claim 1,
characterized in that
from the cross-beams or the riser beams (12, 14) of the stepladder (10), fastening elements emerge for fastening one of receptacles (80, 180) insertable releasably in the hanger (72), such as a hanger or pail.

26. The stepladder according to claim 25,
characterized in that
the receptacle (80, 180) is releasably connected to the beams (12, 14) by a rung-rivet/keyhole recess connection or by spring clips.

27. The stepladder according to claim 25,
characterized in that
the receptacle (80, 180) in the use position of the ladder (10) can be connected to the hanger (72) in a form-fitted and force-fitted manner, particularly form-fitted.

28. The stepladder according to claim 25,
characterized in that
the receptacle such as a hanger (180) exhibits connections elements such as hooks (184, 186) emerging from its cross-edge lying away from the ladder, which are connected to the cross-leg (174) of the hanger (172).

29. The stepladder according to claim 28,
characterized in that
the cross-leg (174) runs staggered to a plane extended by the side-legs (68, 70) of the hanger (172), that with the receptacle (80) connected to the riser beams (12, 14), the connection elements such as hooks (184, 186) run in a plane which extends along the riser beam or approximately in a plane extended by the receptacle.
